(19) United States
(12) Patent Application Publication
(10) Pub. No.: US 2002/0101595 A1
(43) Pub. Date: Aug. 1, 2002

(54) Device and method for inspecting cam profiles

(76) Inventor: Richard M. Johnson, Rockford, IL (US)

Correspondence Address: Mr. William H. Francis, Reising Ethington Barnes, Kisselle Learman & McCulloch, P.C., P. O. Box 4390, Troy, MI, 48099-4390, US

(21) Appl. No.: 09/789,692

(22) Filed: Feb. 21, 2001

Related U.S. Application Data
(63) Continuation of application No. 09/773,331, filed on Jan. 31, 2001, now abandoned.

(51) Int. Cl. G01B 21/20

(52) U.S. Cl. 356/602

(57) ABSTRACT

A device and method for inspecting cam profiles by sensing and storing data points representing the profiles of camshaft cams and comparing this information to known acceptable limits. The device includes an array of laser range finders that are alignable with respective cams of a camshaft to be inspected. The range finders measure the distances to respective outer cam surfaces by reflecting laser light off those surfaces as the cams rotate, calculating angles of reflection by sensing the changing positions of reflected laser light and calculating distances to the respective reflecting points from the angles of reflection. The device also includes a circuit connected to the range finders that determines the dimensions of the cams by analyzing the electrical signals from the range finders as the camshaft rotates.

### REFERENCE TO COPENDING APPLICATION

This application is a continuation of copending application Ser. No. 09/773,331, filed Jan. 31, 2001, entitled “Device and Method For Inspecting Cam Profiles”.

### TECHNICAL FIELD

This invention relates generally to a device and method for inspecting cam profiles.

### BACKGROUND OF THE INVENTION

Devices that inspect the dimensions and relative positioning of cam profiles of camshafts are known in the art. It is desirable that such devices inspect each cam of a camshaft rapidly, reliably and accurately with minimal maintenance requirements. To achieve this, it is also known for certain of these devices to inspect camshafts optically—without physically contacting the cams. Devices that use such non-contact inspection methods experience none of the wear and degradation that can be experienced by devices using various forms of probes and measuring implements that must contact the surface of each inspected cam.

For example, U.S. Pat. No. 4,576,482 issued Mar. 18, 1986 to Pryor and assigned to Diffractor, Ltd. of Canada, discloses a device for inspecting workpieces such as camshafts. The device comprises an electro-optical sensor that includes a light source for illuminating a portion of a workpiece such as a camshaft and a lens for forming an image of the illuminated workpiece portion. The device disclosed in the Diffractor, Ltd. '482 patent also includes an array of photo-sensitive elements, such as photodiodes, that are capable of producing an electrical signal in response to light incident upon them. When light from the light source, including the image, impinges upon the array, the array produces electrical signals that correspond to the shape of a portion of the workpiece. The inspection device of the Diffractor, Ltd. '482 patent also includes a readout unit and computer connected to the array that are configured to determine dimensions of the workpiece portion, such as length, squareness, curvature, etc., by analyzing the electrical signals.

In addition, U.S. Pat. No. 4,585,947 issued to Liptay-Wagner et al. and U.S. Pat. Nos. 5,114,230 and 4,875,776 issued to Pryor, all of which are also assigned to Diffractor, Ltd. each disclose similar electro-optical sensors used for measuring. However, none of the devices disclosed in the Diffractor, Ltd. patents can determine workpiece dimensions without first forming multiple images of the workpiece.

Laser range finders are a known means of measuring distances. They work by emitting pulses of coherent light and directing those pulses at a target. The pulses reflect from a surface of the target and at least a portion of the reflected light is captured by receiving optics. Laser range finders include circuitry that calculates the distance to a reflecting surface by determining the angle of reflection of light off the reflecting surface. To determine the angle of reflection, laser range finders include laser receivers that sense the position where the emitted light beam returns to after reflecting off the reflecting surface.

### SUMMARY OF THE INVENTION

The invention is a device that inspects cam profiles by sensing and storing data points representing the profiles of camshaft cams and comparing this information to known acceptable limits. The device includes a light source configured to direct a beam of light toward at least one cam of a camshaft to be inspected and a photo-sensitive element supported in a position to sense light originating from the light source and reflected from the cam. The photosensitive element is configured to produce an electrical signal corresponding to the sensed light. The device also includes a circuit that is connected to the photosensitive element and is configured to determine the dimensions of the cam by analyzing the electrical signal.

The circuit is configured to measure the distance to an outer surface of the cam by analyzing the electrical signals from the photosensitive element as the camshaft rotates. Therefore, a device constructed according to the invention is able to determine, with a high degree of precision, the dimensions of a cam by measuring the distance to an outer surface of the cam as the camshaft supporting the cam is rotated about a workpiece axis.

The invention also includes a method for inspecting cam profiles that includes supporting a camshaft adjacent a light source and a photosensitive element. A light beam is then directed from the light source onto a cam of the camshaft as the cam shaft rotates such that the cam reflects at least a portion of the light beam to the photosensitive element. The distance to an outer surface of the rotating cam is measured by analyzing electrical signals from the photosensitive element as the camshaft rotates.

Objects, features and advantages of this invention include the ability to inspect cam profiles without physically contacting the inspected cams, the ability to provide accurate measurements with a high degree of reliability, low maintenance requirements, and ease of assembly and use.

### BRIEF DESCRIPTION OF THE DRAWINGS

These and other objects, features and advantages of this invention will be apparent from the following detailed description of the preferred embodiment and best mode, appended claims, and accompanying drawings in which:

FIG. 1 is a perspective view of a cam profile inspection device constructed according to the invention with camshaft mounts of the device in respective retracted positions and with a camshaft in an inspection position aligned with the camshaft mounts;

FIG. 2A is a front view of a left half of the cam profile inspection device of FIG. 1 with the camshaft mounts in respective advanced positions and a camshaft engaged by the camshaft mounts in the inspection position;

FIG. 2B is a front view of a right half of the cam profile inspection device of FIG. 1 with the camshaft mounts in respective advanced positions and a camshaft engaged by the camshaft mounts in the inspection position;

FIG. 3 is a front view of the cam profile inspection device of FIG. 1 with the camshaft mounts in respective advanced positions and a camshaft engaged by the camshaft mounts in the inspection position;

FIG. 4 is a schematic side view of one of a plurality of laser range finders of the cam profile inspection device of FIG. 1 shown measuring the distance to the surface of a camshaft shown in cross-section;

FIG. 5 is a flow chart showing the steps of a method executed according to the invention; and

FIG. 6 is a block diagram showing the relationship between encoder and laser range finders of the invention and a computer.

### DETAILED DESCRIPTION

A device that inspects cam profiles by sensing and storing data points representing the profiles of camshaft cams and comparing this information to known acceptable limits is shown at 10 in the Figures. The device 10 includes five light sources 12, 14, 16, 18, 20, four of which direct beams of light toward cams 22, 24, 26, 28 of a camshaft 30 to be inspected. The device 10 also includes five corresponding photosensitive elements 32, 34, 36, 38, 40, four of which are supported in respective positions to sense light originating from the four cam-directed light sources 12, 14, 16, 18 and reflected from the cams 22, 24, 26, 28. The photosensitive-elements 32, 34, 36, 38, 40 produce electrical signals corresponding to the sensed light. The device 10 also includes a circuit 42 connected to the photo-sensitive elements 32, 34, 36, 38, 40 and configured to determine the dimensions of the cams 22, 24, 26, 28 by analyzing the electrical signals. The circuit 42 measures the distances to outer surfaces of the cams 22, 24, 26, 28 by analyzing the electrical signals from the photosensitive elements 32, 34, 36, 38, 40 as the camshaft 30 is rotated.

Each camshaft 30 to be inspected is removably supported on a fixturing device 41 including a pair of camshaft mounts 44, 46. The camshaft mounts 44, 46 include respective chucks 48, 50 that receive and grip axially opposite ends of each camshaft 30 to be inspected and support each camshaft 30 for rotational motion during inspection. A drive motor 52 is supported on a second 46 of the two camshaft mounts 44, 46 and is operatively connectable to each camshaft 30 to be inspected to rotate each camshaft 30 during inspection.

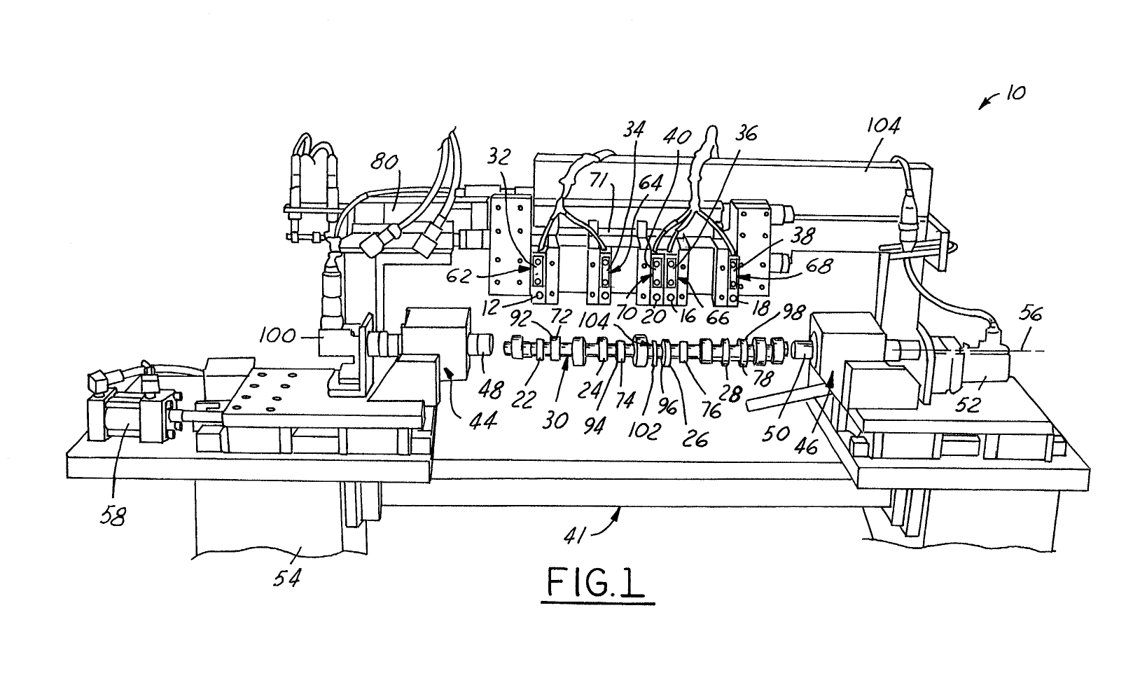

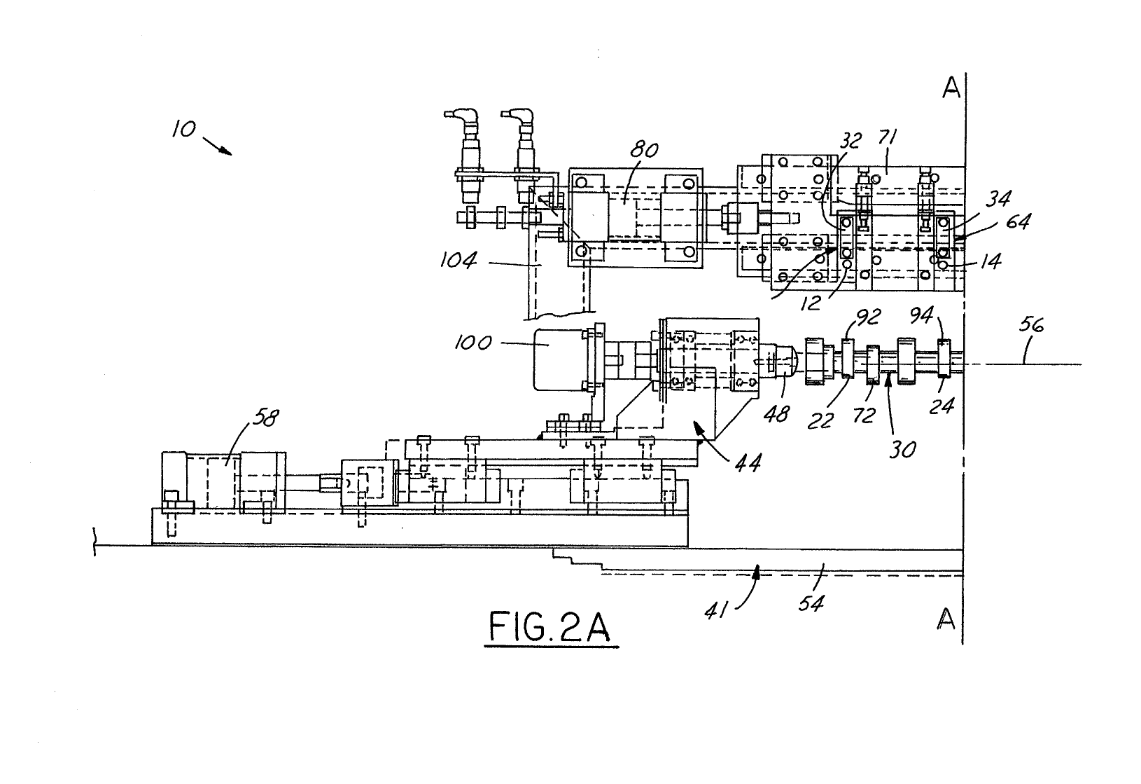

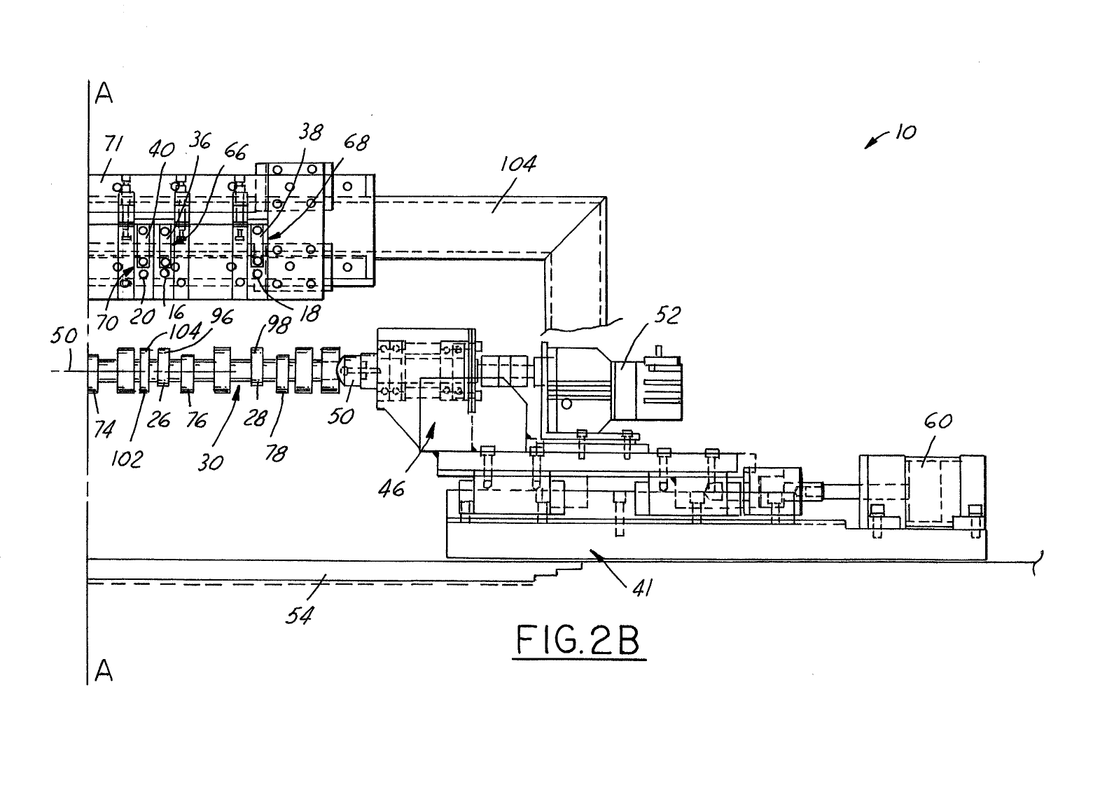

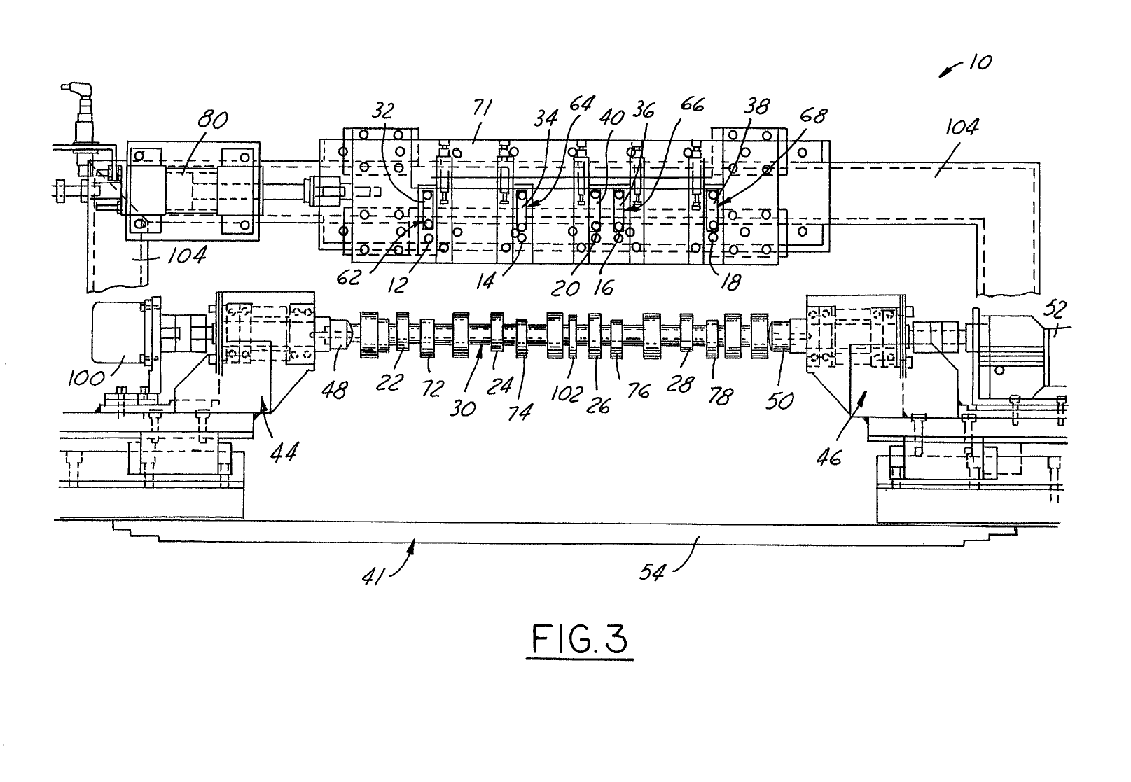

The camshaft mounts 44, 46 are supported on a base 54 for linear reciprocal motion parallel to an axis 56 of the camshaft 30 to be inspected. The camshaft mounts 44, 46 are movable between a retracted position for releasing or loading a camshaft 30 as shown in FIG. 1 and an advanced position for engaging a camshaft 30 and holding the camshaft 30 as shown in FIGS. 2A, 2B, and 3. Pneumatic cylinders 58, 60 are supported on the base 54 and are operatively connected to the camshaft mounts 44, 46. The pneumatic cylinders 58, 60 drive the camshaft mounts 44, 46 between their respective retracted and advanced positions.

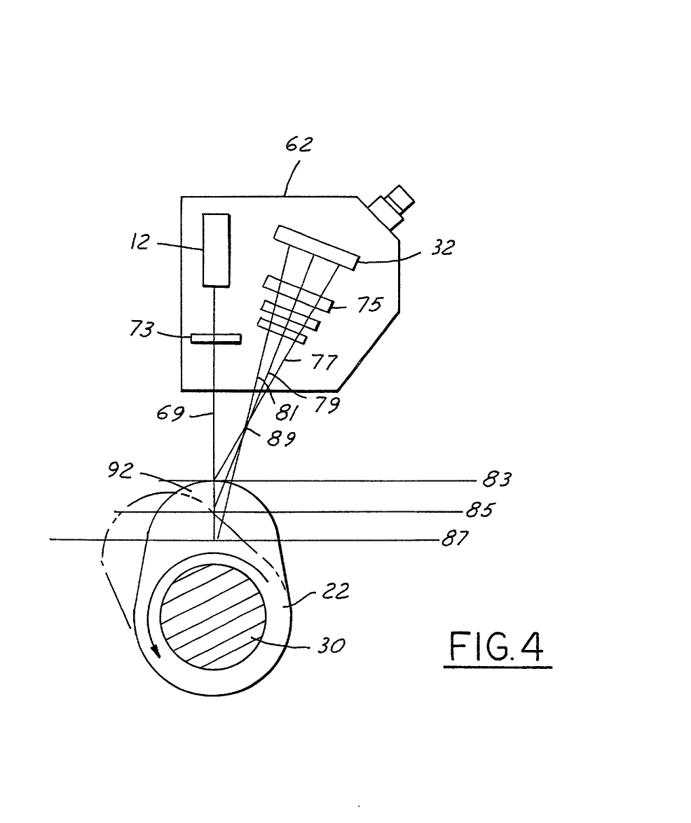

In the present embodiment the device 10 includes an array of five identical laser range finders 62, 64, 66, 68, 70 supported on a slide 71 in spaced positions parallel to and adjacent the camshaft 30 to be inspected. As is representatively shown in FIG. 4 with respect to a first one 62 of the five identical laser range finders, each laser range finder includes one of the light sources 12, 14, 16, 18, 20 (which are laser light sources) and one of the photosensitive elements 32, 34, 36, 38, 40 or laser receivers. While any suitable laser range finder may be used, the laser range finders 62, 64, 66, 68, 70 used in the present embodiment are LC-series ultra-high accuracy laser displacement meters available from Keyence Corporation. Other embodiments may include different numbers of laser range finders depending on the number of cams to be inspected on a given type of camshaft 30. Because the laser range finders are identical, the following description refers only the first laser range finder 62 shown schematically in FIG. 4: The light source emits collimated laser light 69 through an emitter lens 73 and receives back the reflected light through a receiver lens 75. The angle of laser reflection depends on the position of the cam 22. FIG. 4 shows three representative laser reflection paths 77, 79, 81 that result when the laser beam 69 reflects from the cam 22 at three different measurement points 83, 85, 87 on the outer surface of the cam 22 as the cam 22 rotates. Each of the laser reflection paths 77, 79, 81 passes through a focal point 89, then through the receiver lens 75 and onto a portion of the photosensitive laser receiver 32. The laser receiver 32 sends signals to the circuit 42 that correspond to the locations on the receiver 32 where the reflected laser beam 69 hits after reflecting from the outer surface of the rotating cam 22.

The circuit 42 measures the distances to respective outer surfaces of respective cams 22, 24, 26,28 on the camshaft 30 by analyzing the electrical signals from the photosensitive elements 32, 34, 36, 38 of four of the range finders 62, 64, 66, 68 that indicate changes in reflection angle as the camshaft 30 rotates. The laser light sources 12, 14, 16, 18, 20 of the laser range finders 62, 64, 66, 68, 70 update the electrical signals at a rate of 20,000 per second.

The distance measuring circuit 42 is embodied in a computer 43 that, for the first four range finders 62, 64, 66, 68, calculates the distances to a series of points around the outer surfaces of the targeted cams 22, 24, 26, 28. The computer 43 is digital and uses appropriate software to perform its various functions including the distance calculation described above. The computer 43 is programmed to calculate the distance between each respective outer cam surface and each of the first four laser range finders 62, 64, 66, 68. By recording the changing distances to each of the targeted cams 22, 24, 26, 28 as the camshaft 30 rotates, the computer 43 receives sufficient information to determine the shapes of the profiles of the targeted cams 22, 24, 26, 28.

The circuit 42 is further configured to determine the angular position of lobes 92, 94, 96, 98 of the cams 22, 24, 26, 28 on the camshaft 30. To accomplish this, the device 10 includes an encoder 100 that is connected to the camshaft 30 and to the circuit 42. The encoder 100 is supported on the second camshaft mount 46 in a position to monitor the angular position of a camshaft 30 as the drive motor 52 rotates the camshaft 30. While any suitable encoder may be used, the encoder 100 of the present embodiment is available from the BEI Industrial Encoder Division of BEI Technologies, Inc. under model number H25D-SS-1800-ABZC-4469-LED-SM18. The BEI encoder 100 reads 1,800 pulses per revolution, 1 pulse every 0.2 degrees, and can obtain extrapolation pulse readings as small as 0.001 degrees.

The encoder 100 senses the changing angular position of the camshaft 30 during inspection and sends corresponding electrical signals to the circuit 42. A timing ring 102 of each camshaft 30 to be inspected includes a timing notch 104 disposed in a circumferential outer rim of the timing ring 102. A fifth one 70 of the five laser range finders 62, 64, 66, 68, 70 is configured and positioned to sense each passage of the timing notch 104 as the camshaft 30 rotates during inspection. The fifth range finder 70 sends corresponding electrical signals in the form of reference pulses to the circuit 42. The circuit 42 locates and inspects leading and trailing edges of the timing notch 104 by analyzing the electrical signals from the fifth range finder 70. The circuit 42 also determines the position of a high point of each cam lobe 92, 94, 96, 98 on the camshaft 30 relative to the timing notch 104 by correlating the electrical signals representing distance to the cams 22, 24, 26, 28 with the electrical signals representing the angular position of the camshaft 30.

The slide 71 that supports the array of laser range finders 62, 64, 66, 68, 70 generally parallel to a camshaft 30 to be inspected is supported on an upper support frame 104 for linear reciprocal motion between a first inspection position shown in FIGS. 1, 2A and 2B and a second inspection position shown in FIGS. 3A and 3B. The slide 71 allows the first four laser range finders 62, 64, 66, 68 to be directed at different sets of cams on the camshaft 30 when the number of cams exceeds four. More specifically, in the first inspection position the first four laser range finders 62, 64, 66, 68 are directed at the first set of four cams 22, 24, 26 and 28. In the second inspection position the first four laser range finders 62, 64, 66, 68 are directed at a second set of four cams 72, 74, 76, 78. A pneumatic linear slide positioner 80 is connected to the slide 71 and moves the slide 71 between the first and second inspection positions.

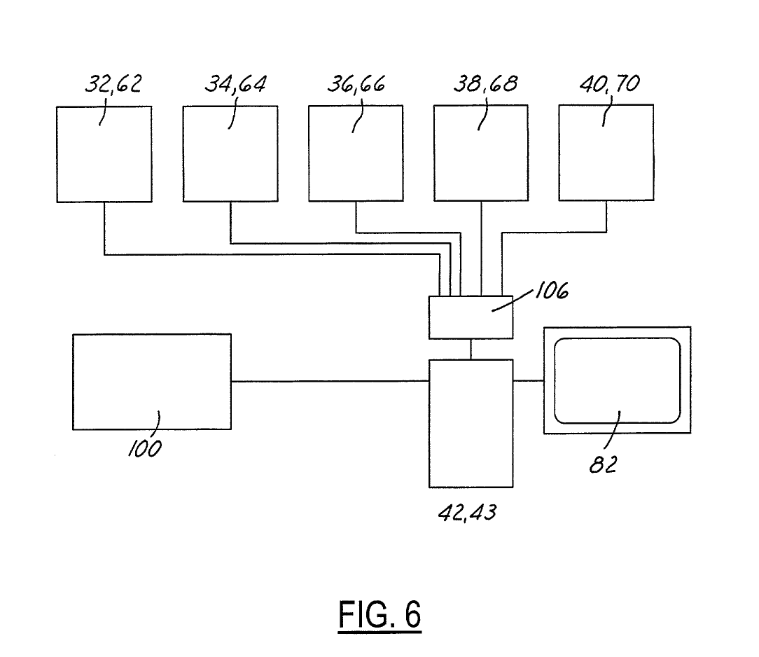

As shown in FIG. 6, the device 10 includes a display screen 82 configured to display the shape and position of the cams 22, 24, 26, 28; 72, 74, 76, 78 of a camshaft 30 being inspected relative to a set of predetermined target shapes and positions. After analyzing the information received from the encoder 100 and the laser range finders 62, 64, 66, 68, 70, the computer 43 further processes that information into signals that, when transmitted to the display screen 82, provide visual representations of the shapes and positions of the cams 22, 24, 26, 28; 72, 74, 76, 78 compared to a predetermined desired set of values. The display screen 82 may be of any suitable type known in the art and preferably one capable of achieving image resolution to 0.00002 inches.

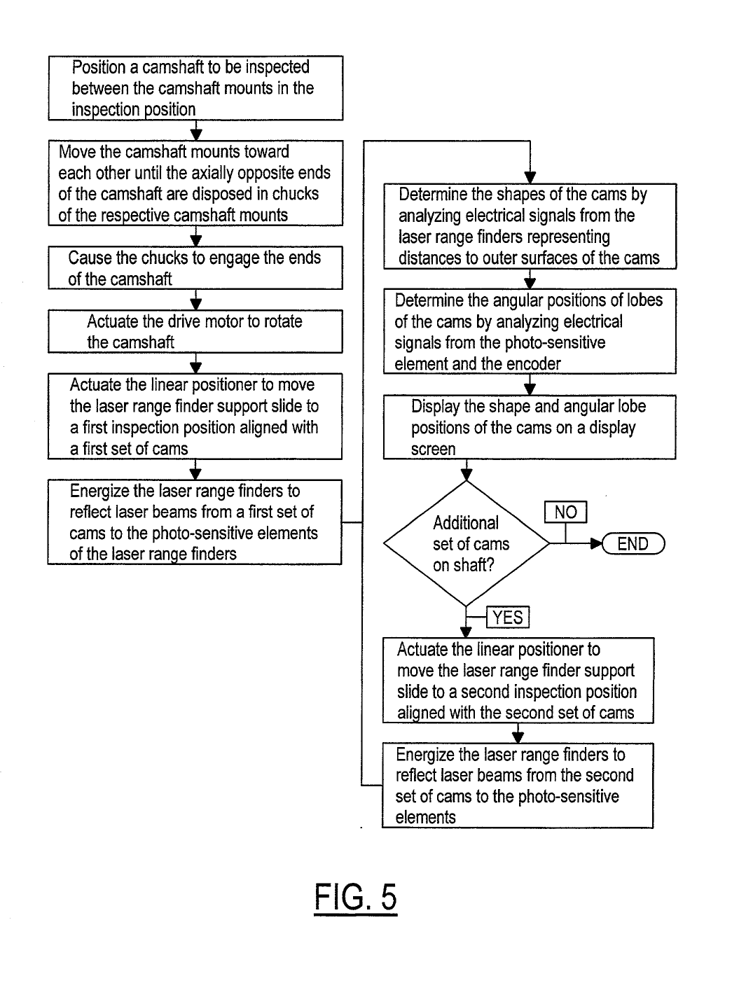

In practice, as shown in the flow chart of FIG. 5, the device 10 described above can be used to sense, store and compare data points representing the profiles of camshaft cams 22, 24, 26, 28; 72, 74, 76, 78 to known acceptable limits. A camshaft 30 to be inspected is first supported on the camshaft mounts 44, 46 adjacent the laser range finders 62, 64, 66, 68, 70. To mount the camshaft 30, axially opposite ends of the camshaft 30 are received in the chucks of the camshaft mounts 44, 46. The chucks 48, 50 are opened, the camshaft 30 to be inspected is positioned in alignment between the mounts 44, 46, and the pneumatic mount cylinders 58, 60 are actuated to move the mounts 44, 46 from their retracted to their advanced positions. The chucks 48, 50 are then tightened to secure the ends of the camshaft 30.

The drive motor 52 is then actuated to rotate the camshaft 30 and the linear slide positioner 80 is actuated to move the slide 71 supporting the laser range finders 62, 64, 66, 68, 70 to the first inspection position (if the slide 71 is not already in the first inspection position). The laser range finders 62, 64, 66, 68, 70 are then energized. The laser light sources 12, 14, 16, 18 of first, second, third and fourth ones of the five laser range finders 62, 64, 66, 68, 70 emit laser beams toward respective cams 22, 24, 26, 28 of the cam shaft 30 such that the cams 22, 24, 26, 28 reflect at least a portion of the laser beams to the corresponding photo-sensitive elements 32, 34, 36, 38 of those four range finders 62, 64, 66, 68. The laser light source 20 of a fifth laser range finder 70 emits a laser beam toward the timing ring 102 such that the photo-sensitive element 40 of the remaining range finder 70 senses whenever the timing notch 104 of the timing ring passes through the beam.

Electrical signals from the five laser range finders 62, 64, 66, 68, 70 and the encoder 100 are transmitted to the computer 43 where they are analyzed, processed and transmitted to the display screen 82 as described above. More specifically, each laser range finder 62, 64, 66, 68, 70 sends analog signals to a high speed input module 106 that converts the analog signals to digital signals to be sent to the computer 43 for processing as is well known in the art. The high-speed input module 106 is a PCI-6023E High Speed Multifunction I/O Board installed in the backplane of the computer 43.

The analog signals from the laser range finders 62, 64, 66, 68, 70 are proportional to the actual distances between the respective laser light sources 12, 14, 16, 18, 20 and the outer surfaces of the first set of cams 22, 24, 26, 28 or timing ring 102 that the respective laser light sources are aligned with. Each analog signal has a voltage that varies from 0-10 volts DC. The high speed input module 106 converts each analog signal to a digital value in a known manner. The resulting digital values are stored in an array. Data received from the encoder is stored in a similar manner. The arrays are then linked in a known manner to provide the timing and associations required to prepare the output display on the screen 82.

As the camshaft 30 rotates, the respective distances between the first four laser light sources 12, 14, 16, 18 and the first set of cams 22, 24, 26, 28 change resulting in corresponding changes in the values of the respective analog signals that the first four range finders 62, 64, 66, 68 are transmitting to the computer. The distance between the fifth laser light source 20 and the outer surface of the timing ring changes substantially only when the timing notch passes. The passage of the notch results in sudden distance changes which are reflected in corresponding changes in the analog signal that the fifth range finder 70 provides to the computer.

At the same time that the computer 43 is receiving analog signals from the laser range finders, the computer 43 is also receiving pulses from the encoder 100. The computer 43 calculates and monitors the radial position of rotating camshaft 30 by digitally counting the encoder pulses. The computer 43 calculates the profile of each cam of the first set of cams 22, 24, 26, 28 and the positions of the leading and trailing edges of the timing notch 104 by correlating the analog “distance” signals with the count of digital “angle” signals. The computer 43 stores and compares all this data and calculates a phase angle for each cam of the first set of cams 22, 24, 26, 28 by comparing the profile data for the individual cam lobes. (The phase angle of a cam on a cam shaft is the circumferential angular position of a high point of that cam as measured from a reference point on the shaft such as the high point of a designated reference cam or “zero degree” cam.) The computer 43 also analyzes the rising and falling angles, or slopes, of each cam lobe.

After the computer 43 has received sufficient information to properly inspect the first set of cams 22, 24, 26, 28 on the camshaft 30, the linear slide positioner 80 is actuated to move the slide 71 supporting the laser range finders 62, 64, 66, 68, 70 to the second inspection position. In the second inspection position the laser light sources 12, 14, 16, 18 of the first, second, third and fourth laser range finders 62, 64, 66, 68 emit laser beams toward a second set of four cams 72, 74, 76, 78 of the cam shaft 30 such that the second set of cams 72, 74, 76, 78 reflect at least a portion of the laser beams to the corresponding photo-sensitive elements 32, 34, 36, 38 of those four range finders 62, 64, 66, 68. Electrical signals from the first, second, third, and fourth laser range finders 62, 64, 66, 68 and the encoder 100 are transmitted to the computer 43 where they are analyzed, processed and transmitted to the display screen 82 as described above with regard to the first set of cams 22, 24, 26, 28. The computer 43 disregards any signals received from the fifth laser range finder 70 at this stage because the fifth range finder 70 is no longer aligned with the timing ring 102 of the camshaft 30.

The computer limit tests all the above values by comparing them to respective predetermined master reference values. The computer will output a good or bad indication for each value depending on whether the values exceed or vary unacceptably from their respective predetermined reference values.

This description is intended to illustrate certain embodiments of the invention rather than to limit the invention. Therefore, it uses descriptive rather than limiting words. Obviously, it's possible to modify this invention from what the description teaches. Within the scope of the claims, one may practice the invention other than as described.

What is claimed is:

1. A device for inspecting cam profiles comprising:
a light source configured to direct a beam of light toward at least one cam of a camshaft to be inspected;
a photo-sensitive element supported in a position to sense light originating from the light source and reflected from the cam and configured to produce an electrical signal corresponding to the sensed light; and
a circuit connected to the photosensitive element and configured to determine the dimensions of the cam by analyzing the electrical signal;
the circuit configured to measure the distance to an outer surface of the cam by analyzing the electrical signals from the photosensitive element as the camshaft rotates.

2. A device for inspecting cam profiles as defined in claim 1 in which the light source comprises a laser light source configured to emit a laser beam,

3. A device for inspecting cam profiles as defined in claim 2 in which:
the laser light source is configured to emit a plurality of laser pulses;
the photosensitive element is configured to send laser reception position information to the circuit in the form of electrical signals that correspond to the position that the laser pulses strike the photosensitive element after reflecting from a series of points around the outer surface of the cam; and
the circuit is configured to determine the distances to the series of points by measuring corresponding angles of laser pulse reflection from the laser reception position information received from the photosensitive element.

4. A device for inspecting cam profiles as defined in claim 1 in which the circuit is further configured to determine the shape of the cam.

5. A device for inspecting cam profiles as defined in claim 1 in which the circuit is further configured to determine the angular position of a lobe of the cam on the camshaft.

6. A device for inspecting cam profiles as defined in claim 1 in which:
the light source is configured to direct a second beam of laser light toward a second cam of the camshaft to be inspected; and
the assembly includes a second photo-sensitive element connected to the circuit and supported in a position to receive light that the light source reflects off the second cam, the second photo-sensitive element being configured to produce an electrical signal corresponding to the sensed light, the circuit being configured to determine the dimensions of the cams by analyzing the electrical signals from the photo-sensitive elements.

7. A device for inspecting cam profiles as defined in claim 1 in which:
the assembly includes an array of laser range finders supported in spaced positions along and adjacent a camshaft to be inspected; and
each laser range finder includes a laser light source and a photo-sensitive element and is configured and positioned to measure the distances to respective outer surfaces of respective cams on the camshaft by measuring corresponding laser pulse reflection angles from those outer surfaces by sensing the position of the returning light.

8. A device for inspecting cam profiles as defined in claim 7 in which the assembly includes:
a slide supporting the array of laser range finders generally parallel to a camshaft to be inspected, the slide being supported for linear reciprocal motion between two or more inspection positions directing the array of laser range finders at different sets of cams on the camshaft; and
a slide positioner configured to move the slide between the inspection positions.

9. A device for inspecting cam profiles as defined in claim 1 in which the assembly includes:
an encoder connected to the circuit and operably connectable to a camshaft to be inspected and configured to sense the changing angular position of the camshaft and to send corresponding electrical signals to the circuit; and
an additional laser light source and photo-sensitive element configured and positioned to sense each passage of a timing notch of a timing ring of the camshaft as the camshaft rotates during inspection and to send corresponding electrical signals to the circuit, the circuit configured to determine the shape of the cam and the position of a high point of the cam lobe relative to the timing notch by correlating the electrical signals representing distance to the cams with the electrical signals representing the angular position of the camshaft.

10. A device for inspecting cam profiles as defined in claim 9 in which the assembly includes a motor configured to operatively connect to a camshaft to be inspected and to rotate the camshaft during inspection.

11. A device for inspecting cam profiles as defined in claim 10 in which the assembly includes a pair of camshaft mounts configured to receive axially opposite ends of a camshaft to be inspected and to support the camshaft for rotational motion during inspection, the encoder being supported on one of the mounts and the motor being supported on the other.

12. A device for inspecting cam profiles as defined in claim 11 in which at least one of the camshaft mounts is supported for linear motion parallel to an axis of the camshaft to be inspected between a retracted position for releasing a camshaft and an advanced position for engaging a camshaft.

13. A method for inspecting cams including the steps of:
supporting a camshaft adjacent a light source and a photosensitive element;
directing a light beam from the light source onto a cam of the camshaft such that the cam reflects at least a portion of the light beam to the photosensitive element;
rotating the cam shaft; and
measuring the distance to an outer surface of the cam by analyzing electrical signals from the photosensitive element as the camshaft rotates.

14. The method of claim 13 in which the step of supporting a cam shaft adjacent a light source and a photo-sensitive element includes supporting axially opposite ends of the camshaft in respective ones of a pair of camshaft mounts for rotational motion during inspection.

15. The method of claim 14 in which the step of supporting a cam shaft adjacent a light source and a photo-sensitive element includes:
moving at least one of the camshaft mounts in a direction away from the other camshaft mount and parallel to an axis of the camshaft supported in the mounts;
positioning a camshaft between the mounts; and
moving the at least one camshaft mount in a direction toward the other camshaft mount until the ends of the camshaft are supported in the respective mounts.

16. The method of claim 13 in which:
the step of directing a light beam from the light source onto a cam of the cam shaft includes directing the light beam at a second cam on the camshaft by moving the light source and photo-sensitive element along the camshaft from a first inspection position to a second inspection position where the second cam reflects at least a portion of the light beam to the photo-sensitive element; and
the step of measuring the distance includes measuring the distance to an outer surface of the second cam by analyzing electrical signals from the photosensitive element as the camshaft rotates.

17. The method of claim 13 in which the step of directing a light beam includes directing a laser light beam from the light source onto a cam of the cam shaft such that the cam reflects at least a portion of the laser light beam to the photo-sensitive element.

18. The method of claim 13 including the additional step of determining the shape of the cam by analyzing the electrical signals from the photosensitive element.

19. The method of claim 13 including the additional step of determining the angular position of a lobe of the cam on the camshaft by analyzing the electrical signals from the photosensitive element.
